(19) United States
(12) Patent Application Publication
(10) Pub. No.: US 2019/0260498 A1
(43) Pub. Date: Aug. 22, 2019

(54) USER EQUIPMENT AND UPLINK SIGNAL TRANSMISSION METHOD

(71) Applicant: NTT DOCOMO, INC., Tokyo (JP)

(72) Inventors: Hideyuki Moroga, Tokyo (JP); Kazuaki Takeda, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/344,202

(22) PCT Filed: Aug. 23, 2017
(86) PCT No.: PCT/JP2017/030166

§ 371 Date: Apr. 23, 2019

(30) Foreign Application Priority Data
Nov. 2, 2016 (JP) 2016-215706

(51) Int. Cl. H04L 1/00; H04L 27/26; H04W 28/18; H04W 72/04

(52) U.S. Cl. CPC H04L 1/0003; H04W 72/0406; H04W 28/18; H04L 27/26

(57) ABSTRACT

A user equipment according to one embodiment of the present invention is a user equipment that transmits an uplink signal to a base station using one of a multicarrier scheme and a single carrier scheme, which includes a reception unit that receives downlink control information from the base station through a downlink control channel, a determination unit that determines whether the multicarrier scheme is used or the single carrier scheme is used based on the received downlink control information, and a transmission unit that transmits the uplink signal using the determined scheme.

### TECHNICAL FIELD

The present invention relates to a user equipment and an uplink signal transmission method.

### BACKGROUND ART

In a radio communication system of a long term evolution (LTE) scheme, orthogonal frequency division multiple access (OFDMA) is employed for downlink communication, and single carrier-frequency division multiple access (SC-FDMA) is employed for uplink communication (Non-Patent Document 1).

Particularly, in uplink communication, an SC-FDMA scheme capable of suppressing a peak-to-average power ratio (PAPR) to a low level is employed, and discrete Fourier transform-spread-orthogonal frequency multiplexing (DFT-s-OFDM) is used as a technique of generating an uplink signal in a frequency domain. In DFT-s-OFDM, single carrier transmission is implemented in OFDM transmission by providing discrete Fourier transform (DFT) prior to inverse fast Fourier transform (IFFT).

### PRIOR-ART DOCUMENTS

### Non-Patent Documents

[Non-Patent Document 1] 3GPP TS36.201, V8.3.0 (2009-03)

### DISCLOSURE OF INVENTION

### Problem(S) to be Solved by the Invention

In a next generation radio communication system, it is necessary to satisfy requirements for high speed communication and large capacity, and for example, in a fifth generation radio communication system, a peak data rate of 10 Gbps is desired. In order to satisfy these requirements, it is expected that a user equipment which can apply a multicarrier scheme using OFDM to uplink communication will be developed.

Since OFDM differs from DFT-s-OFDM in a generation technique and a decoding technique of uplink signals, unless it is appropriately set whether OFDM is used or DFT-s-OFDM is used between a base station and a user equipment, uplink signals are unable to be received by the base station.

It is an object of the present invention to implement transmission and reception of uplink signals between a base station and a user equipment in a radio communication system in which a single carrier scheme and a multicarrier scheme are applicable in uplink communication, by determining by the user equipment which of the schemes is used for uplink communication based on information transmitted from the base station.

### Means for Solving the Problem(S)

A user equipment according to one embodiment of the present invention is a user equipment that transmits an uplink signal to a base station using one of a multicarrier scheme and a single carrier scheme, which includes a reception unit that receives downlink control information from the base station through a downlink control channel, a determination unit that determines whether the multicarrier scheme is used or the single carrier scheme is used based on the received downlink control information, and a transmission unit that transmits the uplink signal using the determined scheme.

### ADVANTAGEOUS EFFECT OF THE INVENTION

According to the present invention, it is possible to implement transmission and reception of uplink signals between a base station and a user equipment in a radio communication system in which a single carrier scheme and a multicarrier scheme are applicable in uplink communication, by determining by the user equipment which of the schemes is used for uplink communication based on information transmitted from the base station.

### BRIEF DESCRIPTION OF THE DRAWINGS

FIG. 1 is a schematic diagram illustrating a configuration example of a radio communication system according to an embodiment of the present invention;

FIG. 2 is a sequence diagram of an uplink signal transmission method in a radio communication system according to an embodiment of the present invention;

FIG. 3 is a block diagram illustrating a functional configuration of a base station according to an embodiment of the present invention;

FIG. 4 is a block diagram illustrating a functional configuration of a user equipment according to an embodiment of the present invention; and

FIG. 5 is a diagram illustrating an example of a hardware configuration of a radio communication device according to an embodiment of the present invention.

### DETAILED DESCRIPTION OF THE EMBODIMENTS

Hereinafter, an embodiment of the present invention will be described with reference to the accompanying drawings. An embodiment to be described below is merely an example, and an embodiment to which the present invention is applied is not limited to the following embodiment. For example, a radio communication system according to the present embodiment is supposed to be a successor radio communication system of LTE, but the present invention is not limited to the successor radio communication system of LTE and can be also applied to other systems.

### System Configuration

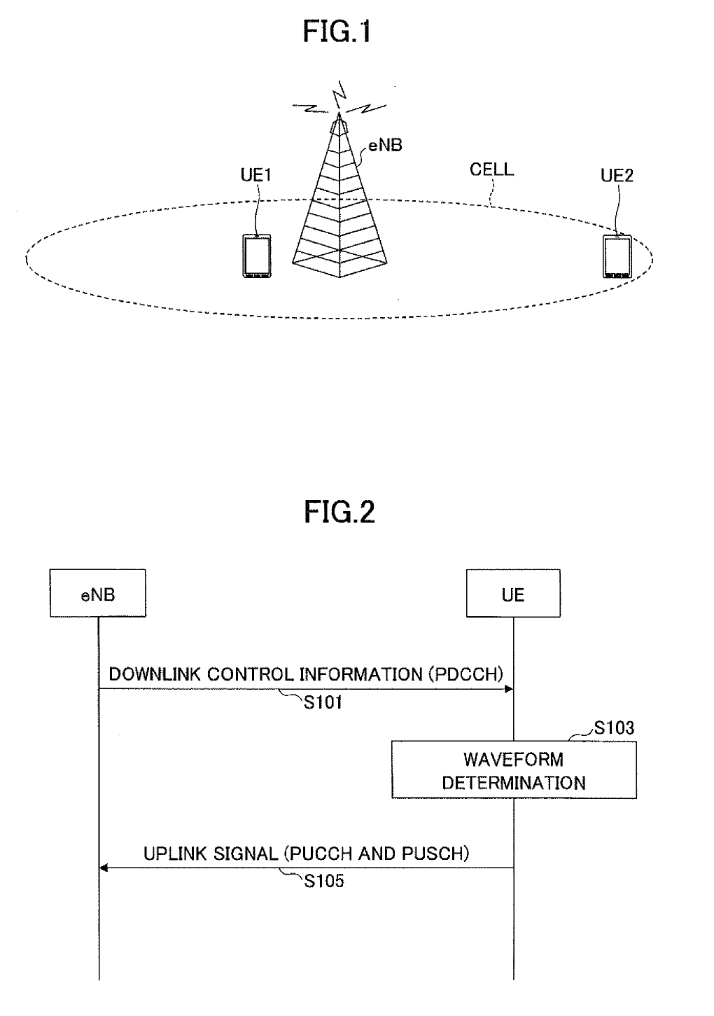

FIG. 1 is a schematic diagram illustrating a configuration example of a radio communication system according to an embodiment of the present invention. As illustrated in FIG. 1, the radio communication system according to the embodiment of the present invention includes a base station eNB and user equipments UE1 and UE2. In the example of FIG. 1, one base station eNB and two user equipments UE1 and UE2 (which are collectively referred to as “UE”) are illustrated, but a plurality of base stations eNBs and one user equipment or three or more user equipments UEs may be included.

The base station eNB can accommodate one or more (for example, three) cells (which is also referred to as “sectors”). When the base station eNB accommodates a plurality of cells, the entire coverage area of the base station eNB can be partitioned into a plurality of small areas, and in each small area, a communication service can be provided through a base station subsystem (for example, a small indoor base station remote radio head (RRH)). The term “cell” or “sector” refers to a part or whole of the coverage area in which the base station and/or the base station subsystem provides a communication service. Further, the terms “base station”, “eNB”, “cell”, and “sector” may be used interchangeably in this specification. The base station eNB is also referred to as a fixed station, a Node B, an eNode B (eNB), an access point, a femtocell, a small cell, or the like.

The user equipment UE is also referred to as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or any other appropriate term, by those having skill in the art.

The base station eNB and the user equipment UE perform downlink (DL) communication and uplink (UL) communication using a predetermined band.

First, main channels used for downlink communication will be described.

It is necessary for the user equipment UE to receive broadcast information that is basic information in order to communicate with the base station eNB. The broadcast information includes a master information block (MIB) including a system bandwidth, a system frame number, and the like and a system information block (SIB) that is another kind of system information. The SIB may be transmitted by a downlink data channel which will be described later.

The user equipment UE receives downlink control information (DCI) including allocation of a resource or the like using a downlink control channel. The downlink control channel may be referred to as a physical downlink control channel (PDSCH).

The user equipment UE receives downlink data using a downlink shared channel (downlink data channel). The downlink shared channel may be referred to as a physical downlink shared channel (PDSCH).

Next, main channels used for uplink communication will be described.

The user equipment UE transmits uplink control information including ACK/NACK for the PDSCH, reception quality of the downlink channel, a scheduling assignment request, and the like, using an uplink control channel. The uplink control channel may be referred to as a physical uplink control channel (PUCCH).

Further, the user equipment UE transmits uplink data using an uplink shared channel (uplink data channel). The uplink shared channel may be referred to as a physical uplink shared channel (PUSCH).

The channels and the signals mentioned above are examples in LTE, and names different from those mentioned above may be used.

The channels and the signals are transmitted, for example, in predetermined portions in resources configured in a time domain and a frequency domain. A radio frame may be formed by one or more frames in the time domain. Each of one or more frames in the time domain is also referred to as a subframe. Further, the subframe may be formed by one or more slots in the time domain. Further, the slot may be formed by one or more symbols (OFDM symbols, SC-FDMA symbols, or the like) in the time domain. Each of the radio frame, the subframe, the slot, and the symbol indicates a time unit in which a signal is transmitted. The radio frame, the subframe, the slot, and the symbol may have different corresponding names. For example, in an LTE system, the base station performs scheduling to allocate a radio resource (a frequency bandwidth, transmission power, or the like which can be used by each mobile station) to each mobile station. A minimum time unit of scheduling may be referred to as a transmission time interval (TTI). For example, one subframe may be referred to as a TTI, a plurality of consecutive subframes may be referred to as a TTI, one slot may be referred to as a TTI, or one of a plurality of mini-slots obtained by dividing one slot may be referred to as a TTI.

A resource block (RB) is a resource allocation unit in the time domain and the frequency domain and may include one or more consecutive subcarriers in the frequency domain. In the time domain of the resource block, one or more symbols may be included, and one slot, one subframe, or one TTI may be used. Each of one TTI and one subframe may be formed by one or more resource blocks. The structure of the radio frame described above is merely an example, and the number of subframes included in the radio frame, the number of slots or mini-slots included in the subframe, the number of symbols and resources blocks included in the slot or the mini-slot, and the number of subcarriers included in the resource block can be changed in many ways.

In the radio communication system according to the embodiment of the present invention, it is assumed that a multicarrier scheme using OFDM and a single carrier scheme using DFT-s-OFDM are applicable in uplink communication. In OFDM, it is possible to implement high-speed transmission and improve frequency usage efficiency by arranging subcarriers on a frequency. Therefore, a high throughput can be achieved by applying the multicarrier scheme using OFDM to a user equipment (the UE1 in FIG. 1) in the vicinity of the center of the cell. On the other hand, in DFT-s-OFDM, transmission is performed using a consecutive frequency band. In DFT-s-OFDM, since a fluctuation in transmission power is small, it is possible to increase an output voltage of a user equipment and achieve a wide coverage. Therefore, a wide coverage can be achieved by applying the single carrier scheme using DFT-s-OFDM to a user equipment (the UE2 in FIG. 1) in the vicinity of the cell edge.

When the multicarrier scheme as well as the single carrier scheme can be applied in uplink communication, switching between the multicarrier scheme and the single carrier scheme may be allowed in the cell. In the embodiment of the present invention, transmission and reception of uplink signals between the base station eNB and the user equipment UE are implemented such that the base station eNB indicates to the user equipment UE in advance that both the multicarrier scheme and the single carrier scheme are applicable in uplink communication, and the user equipment UE determines which of the schemes is used based on downlink control information transmitted from the base station eNB.

### Procedure of Uplink Signal Transmission Method

FIG. 2 is a sequence diagram of an uplink signal transmission method in the radio communication system according to the embodiment of the present invention.

The base station eNB may generate signal waveform configuration information indicating that both the multicarrier scheme and the single carrier scheme are applicable in uplink communication and transmit the signal waveform configuration information to the user equipment UE in advance (not illustrated). Alternatively, the signal waveform configuration information may be set in the base station eNB and the user equipment UE in advance.

In the following description, information indicating either or both of the multicarrier scheme and the single carrier scheme to be applicable in uplink communication is referred to as “signal waveform configuration information” or a “waveform configuration”. Further, the scheme (the multicarrier scheme or the single carrier scheme) used in uplink is referred to as “signal waveform” or “waveform”. The waveform configuration may be (1) information indicating that both the multicarrier scheme and the single carrier scheme are applicable within the cell of the base station eNB, and dynamic switching is performed, (2) information indicating that both the multicarrier scheme and the single carrier scheme are applicable within the cell of the base station eNB, and semi-static switching is performed, or (3) information indicating that only the multicarrier scheme is applicable within the cell of the base station eNB. Since the embodiment of the present invention focuses on switching between the multicarrier scheme and the single carrier scheme, the waveform configuration is assumed to be (1) the information indicating that both the multicarrier scheme and the single carrier scheme are applicable within the cell of the base station eNB, and dynamic switching is performed or (2) the information indicating that both the multicarrier scheme and the single carrier scheme are applicable within the cell of the base station eNB, and semi-static switching is performed. Here, the dynamic switching may be expressed as switching on a subframe basis, and, for example, indicates switching between the multicarrier scheme and the single carrier scheme through DCI. Further, the semi-static switching may be expressed as switching in a fixed duration or a variable duration longer than one subframe.

The waveform configuration may be a waveform configuration common to all user equipments in the cell or may be a waveform configuration provided for each user equipment, for example, based on capability information (UE capability) of the user equipment. The UE capability includes information about a frequency band, a UE category, a maximum transmission rate, and the like supported by the user equipment UE. The UE capability may further include information indicating whether static or dynamic switching between the multicarrier scheme and the single carrier scheme is possible and the like. Further, a common waveform configuration may be used for the PUCCH and the PUSCH, and separate waveform configurations may be used for the PUCCH and the PUSCH.

The base station eNB transmits downlink control information to the user equipment UE through the PDCCH (S101).

The downlink control information transmitted through the PDCCH is referred to as “DCI”, and a plurality of formats (DCI formats) are prepared for the DCI. The DCI format may be associated with a rank. For example, a DCI format 0 corresponds to a rank 1, and a DCI format 4 corresponds to a rank 2.

Further, the DCI includes scheduling information which is allocated by the base station eNB to the user equipment UE. The scheduling information in uplink communication is particularly referred to as an “UL scheduling grant”, and the scheduling information includes resource block allocation information, a modulation scheme and a channel coding rate (a modulation and coding scheme (MCS)), a data size (a transport block size (TBS)), and the like. The resource block allocation information indicates a location of one or more resources blocks allocated by the base station eNB so that the user equipment UE transmits the PUSCH.

The base station eNB can use the DCI in order for the user equipment UE to transmit an uplink signal using one of the multicarrier scheme and the single carrier scheme. For example, in order for a user equipment (the UF1 in FIG. 1) in the vicinity of the center of the cell to transmit an uplink signal in accordance with the multicarrier scheme using OFDM, DCI associated with the multicarrier scheme is used. For example, in order for a user equipment (the UE2 in FIG. 1) in the vicinity of the cell edge to transmit an uplink signal in accordance with the single carrier scheme using DFT-s-OFDM, DCI associated with the single carrier scheme is used. It may be determined whether a user equipment resides in the vicinity of the center of the cell or in the vicinity of the cell edge in accordance with a reception quality measurement or the like.

One of the multicarrier scheme or the single carrier scheme to be used in the uplink communication (that is, a waveform) may be associated with a rank. For example, a rank lower than or equal to a certain value (for example, the rank 1 (corresponding to the DCI format 0)) may be associated with the single carrier scheme, and a rank higher than the certain value (for example, the rank 2 (corresponding to the DCI format 4)) may be associated with the multicarrier scheme.

Alternatively, the waveform may be associated with a modulation scheme. For example, modulation schemes of a certain order or lower (for example, BPSK, π/2 shift BPSK, QPSK, and π/4 shift QPSK) may be associated with the single carrier scheme, and modulation schemes higher than the certain order (for example, 16 QAM, 64 QAM, and 256 QAM) may be associated with the multicarrier scheme.

Alternatively, the waveform may be associated with an MCS. For example, an MCS of a certain value or less may be associated with the single carrier scheme, and an MCS larger than the certain value may be associated with the multicarrier scheme.

Alternatively, the waveform may be associated with the number of allocated resources blocks. For example, the number of allocated resources blocks which is a certain value or smaller may be associated with the single carrier scheme, and the number of allocated resources blocks which is larger than the certain value may be associated with the multicarrier scheme.

Alternatively, the waveform may be associated with a data size (TBS). For example, a data size of a certain value or smaller may be associated with the single carrier scheme, and a data size larger than the certain value may be associated with the multicarrier scheme.

Alternatively, the waveform may be associated with a precoding matrix (a precoding matrix indicator (PMI)). Since the precoding matrix varies depending on the rank, determination using the preceding matrix is also possible. For example, a specific precoding matrix may be associated with the single carrier scheme, and a precoding matrix other than the certain precoding matrix may be associated with the multicarrier scheme.

Alternatively, the waveform may be associated with a scheme of allocating resources blocks. For example, a consecutive allocation may be associated with the single carrier scheme, and a non-consecutive (discrete) allocation may be associated with the multicarrier scheme. The consecutive allocation indicates allocating of consecutive resource blocks from an allocation start position to an allocation end position on a frequency axis to the user equipment UE. Further, the non-consecutive allocation indicates a mixture of resources blocks which are allocated to the user equipment UE and resource blocks which are not allocated to the user equipment UE from the allocation start position to the allocation end position on the frequency axis. Whether the allocation is consecutive or non-consecutive may be distinguished in accordance with an allocation type. For example, when the allocation of resources blocks can be designated by the allocation start position and the number of allocated resources blocks, it is determined as a consecutive allocation type and may be associated with the single carrier scheme.

The user equipment UE receives downlink control information from the base station eNB through the PDCCH and determines a waveform based on the downlink control information (S103).

As described above, the user equipment UE can determine a rank, scheduling information (resources block allocation information, an MCS, a data size, and the like), a precoding matrix, and the like by decoding the DCI.

For example, the user equipment UE determines that the single carrier scheme is to be used when the rank is a certain value or lower (for example, the rank 1), and determines that the multicarrier scheme is to be used when the rank is higher than the certain value (for example, the rank 2).

For example, the user equipment UE determines that the single carrier scheme is to be used when the modulation scheme is a certain order or lower (for example, BPSK, π/2 shift BPSK, QPSK, or π/4 shift QPSK) and determines that the multicarrier scheme is to be used when the modulation scheme is higher than the certain order (for example, 16 QAM, 64 QAM, or 256 QAM).

For example, the user equipment UE determines that the single carrier scheme is to be used when the MCS is a certain value or less, and determines that the multicarrier scheme is to be used when the MCS is larger than the certain value.

For example, the user equipment UE determines that the single carrier scheme is to be used when the number of allocated resources blocks is a certain value or smaller and determines that the multicarrier scheme is to be used when the number of allocated resources blocks is larger than the certain value.

For example, the user equipment UE determines that the single carrier scheme is to be used when the data size is a certain value or smaller and determines that the multicarrier scheme is to be used when the data size is larger than the certain value.

For example, the user equipment determines that the single carrier scheme is to be used in the case of a specific precoding matrix and determines that the multicarrier scheme is to be used in the case of a precoding matrix other than the specific precoding matrix.

For example, the user equipment determines that the single carrier scheme is to be used when the allocation of resource blocks is consecutive, and determines that the multicarrier scheme is to be used when the allocation of resource blocks is not consecutive (discrete).

Further, a waveform determination criterion serving as a switching point between the multicarrier scheme and the single carrier scheme may be set in the base station eNB and the user equipment UE in advance. Further, the waveform determination criterion may be provided from the base station eNB to the user equipment UE using broadcast information (MIB and/or SIB), a message in a random access procedure (for example, an RA response (also referred to as a message 2)), a message in a connection setup (RRC connection setup or S1 connection setup) procedure (for example, an RRC connection setup or an RRC connection reconfiguration), or the like. The user equipment UE can determine a waveform based on the waveform determination criterion and the rank, the scheduling information (the resource block allocation information, the MCS, the data size, and the like), the precoding matrix, or the like which is obtained by decoding the DCI.

When different waveform configurations are used for the PUCCH and the PUSCH, or when different waveforms can be applied to the PUCCH and the PUSCH, the user equipment UE determines a waveform for the PUCCH and a waveform for the PUSCH. The waveform for the PUCCH and the waveform for the PUSCH may be determined based on different kinds of information. For example, the waveform for the PUCCH may be determined based on the rank, and the waveform for the PUSCH may be determined based on the resources block allocation information. The determination using the rank and the resource block allocation information is merely an example, and any information in the DCI may be used for the determination of the waveform for the PUCCH and the waveform for the PUCCH.

As described above, in the embodiment of the present invention, the waveform configuration is assumed to be (1) the information indicating that both the multicarrier scheme and the single carrier scheme are applicable within the cell of the base station eNB, and dynamic switching is performed or (2) the information indicating that both the multicarrier scheme and the single carrier scheme are applicable within the cell of the base station eNB, and semi-static switching is performed.

When the waveform configuration is (1) the information indicating that both the multicarrier scheme and the single carrier scheme are applicable within the cell of the base station eNB, and dynamic switching is performed, the user equipment UE can determine a waveform by decoding DCI on a subframe basis as described above.

When the waveform configuration is (2) the information indicating that both the multicarrier scheme and the single carrier scheme are applicable within the cell of the base station eNB, and semi-static switching is performed, the user equipment UE may determine a waveform at each fixed time interval. For example, if a fixed time has not elapsed since the waveform was determined, the user equipment UE does not determine a waveform even when DCI is received, and determines a waveform based on DCI received after the fixed time has elapsed. The fixed time used for the timing of determining the waveform may be set in the base station eNB and the user equipment UE in advance or may be provided from the base station eNB to the user equipment UE using broadcast information, a message in a random access procedure, a message in a connection setup procedure, or the like.

Alternatively, when the waveform configuration is (2) the information indicating that both the multicarrier scheme and the single carrier scheme are applicable within the cell of the base station eNB, and semi-static switching is performed, the user equipment UE may determine a waveform based on another kind of control timing. Specifically, the user equipment UE determines a waveform based on DCI received after a predetermined time has elapsed since control information was transmitted to the base station eNB. For example, since the user equipment UE transmits a measurement report when a condition that the reception quality is lower than a threshold value is satisfied or the like, the base station eNB may determine whether the waveform should be changed after receiving the measurement report and transmit DCI associated with the determined waveform. The user equipment UE may determine a waveform after N subframes have elapsed since the user equipment UE transmitted the measurement report. For example, the user equipment UE transmits NACK when it fails to receive the PDSCH, and thus the base station eNB may determine whether the waveform should be changed when NACK is continuously received M times and transmit DCI associated with the determined waveform. The user equipment UE may determine a waveform after N subframes have elapsed since the user equipment UE continuously transmitted NACK M times. Further, the base station eNB may determine whether the waveform should be changed when ACK is continuously received L times and transmit DCI associated with the determined waveform. The user equipment UE may determine a waveform after N subframes have elapsed since the user equipment continuously transmitted ACK L times.

The user equipment UE transmits an uplink signal using the determined waveform (S105).

Since the user equipment UE can determine one of the multicarrier scheme or the single carrier scheme to be used based on the DCI, the user equipment UE transmits the uplink signal using the determined scheme.

### Functional Configuration

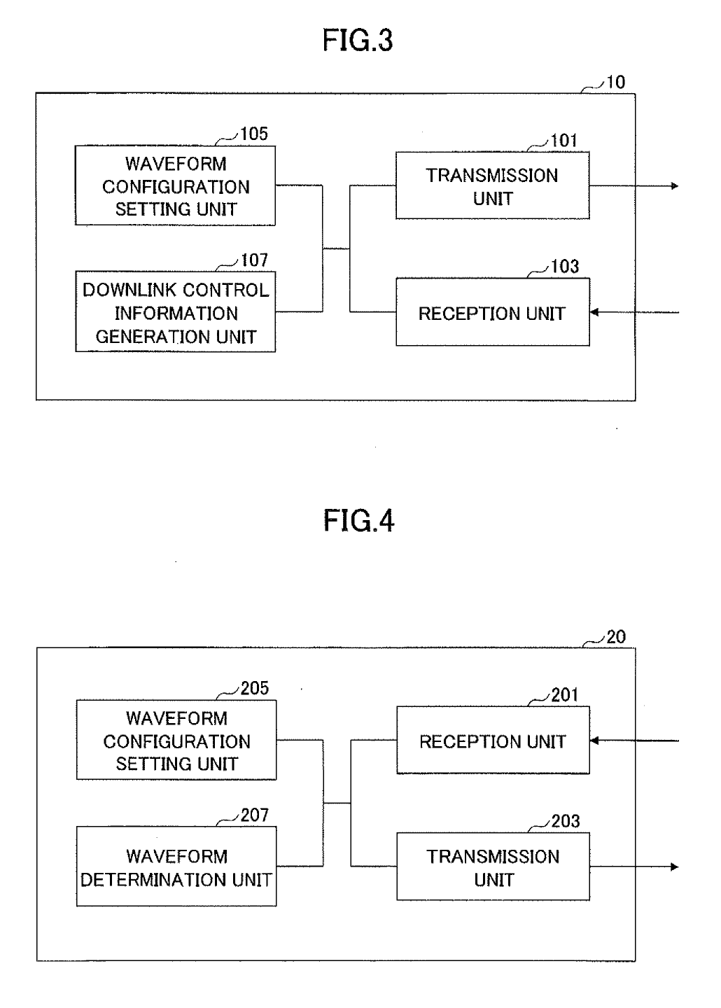

FIG. 3 is a block diagram illustrating a functional configuration of a base station 10 according to the embodiment of the present invention.

The base station 10 has a transmission unit 101, a reception unit 103, a waveform configuration setting unit 105, and a downlink control information generation unit 107.

The transmission unit 101 generates various kinds of downlink signals to be transmitted from the base station 10 and transmits the generated downlink signals to the user equipment UE. The transmission unit 101 transmits DCI generated by the downlink control information generation unit 107 described below to the user equipment UE. Further, the transmission unit 101 may transmit a waveform determination criterion serving as the switching point between the multicarrier scheme and the single carrier scheme to the user equipment UE.

The reception unit 103 receives various kinds of uplink signals from the user equipment UE. The reception unit 103 receives an uplink signal (uplink control information and uplink data) transmitted from the user equipment UE using the multicarrier scheme or the single carrier scheme.

The waveform configuration setting unit 105 sets the waveform configuration determined by the base station eNB or a predetermined waveform configuration. The waveform configuration may be set in common to all users in the cell or may be set for each user equipment, for example, in accordance with the UE capability. Further, the waveform configuration may be set in common to the PUCCH and the PUSCH or may be set separately for the PUCCH and the PUSCH.

The downlink control information generation unit 107 generates DCI to be transmitted to the user equipment UE based on whether the multicarrier scheme is used or the single carrier scheme is used by the user equipment UE. In order for the user equipment UE to use the multicarrier scheme, the downlink control information generation unit 107 generates DCI using the rank, the scheduling information (the resource block allocation information, the MCS, the data size, or the like), or the like which is associated with the multicarrier scheme. In order for the user equipment UE to use the single carrier scheme, the downlink control information generation unit 107 generates DCI using the rank, the scheduling information (the resource block allocation information, the MCS, the data size, or the like), or the like which is associated with the single carrier scheme.

FIG. 4 is a block diagram illustrating a functional configuration of a user equipment 20 according to the embodiment of the present invention.

The user equipment 20 has a reception unit 201, a transmission unit 203, a waveform configuration setting unit 205, and a waveform determination unit 207.

The reception unit 201 receives various kinds of downlink signals from the base station eNB. The reception unit 201 receives the DCI from the base station eNB through the PDCCH. The reception unit 201 may also receive the waveform determination criterion from the base station eNB.

The transmission unit 203 generates various kinds of uplink signals to be transmitted from the user equipment 20 and transmits the generated uplink signals to the base station eNB. The transmission unit 203 transmits the uplink signal in accordance with the waveform determined in the waveform determination unit 207 described below. When separate waveforms can be applied to the PUCCH and the PUSCH, transmission unit 203 transmits the uplink control information on the PUCCH in accordance with the waveform determined for the PUCCH, and transmits the uplink data on the PUSCH in accordance with the waveform determined for the PUSCH.

The waveform configuration setting unit 205 sets the waveform configuration provided from the base station eNB or a predetermined waveform configuration. The waveform configuration may be set in common to the PUCCH and the PUSCH, or may be set separately for the PUCCH and the PUSCH.

The waveform determination unit 207 determines a waveform based on the DCI received through the reception unit 201. The waveform determination unit 207 may determine the waveform based on the waveform determination criterion and the rank, the scheduling information (the resource block allocation information, the MCS, the data size, or the like), the precoding matrix, or the like which is obtained by decoding the DCI. When different waveform configurations are used for the PUCCH and the PUSCH or when different waveforms can be applied to the PUCCH and the PUSCH, the waveform determination unit 207 determines the waveform for the PUCCH and the waveform for the PUSCH.

When the waveform configuration is dynamic switching, the waveform determination unit 207 determines the waveform by decoding the DCI on a subframe basis. When the waveform configuration is semi-static switching, the waveform determination unit 207 may determine the waveform at regular time intervals or may determine the waveform based on another kind of control timing.

### Hardware Configuration

The block diagrams used to describe the above-mentioned embodiment illustrate blocks of functional units. The functional blocks (components) are implemented by an arbitrary combination of hardware and/or software. A means for implementing each functional block is not particularly limited. That is, each functional block may be implemented by one apparatus in which a plurality of elements are physically and/or logically coupled or by a plurality of apparatuses that are physically and/or logically separated from each other and are connected directly and/or indirectly (for example, in a wired manner and/or wirelessly).

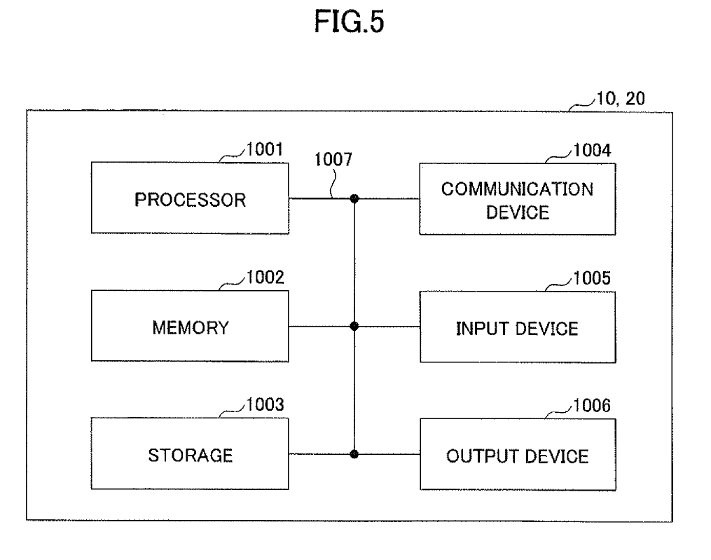

For example, the base station, the user equipment, or the like according to the embodiment of the invention may function as a computer that performs an uplink signal transmission method according to this embodiment. FIG. 5 is a diagram illustrating an example of a hardware configuration of the base station 10 or the user equipment 20 according to this embodiment. Each of the base station 10 and the user equipment 20 may be physically configured as a computer device including, for example, a processor 1001, a memory 1002, a storage 1003, a communication device 1004, an input device 1005, an output device 1006, and a bus 1007.

In the following description, the term “device” can be substituted with, for example, a circuit, an apparatus, or a unit. The hardware configuration of the base station 10 or the user equipment 20 may include one or a plurality of devices illustrated in FIG. 5 or may not include some of the devices.

Each function of the base station 10 and the user equipment 20 may be implemented by the following process: predetermined software (program) is read onto hardware such as the processor 1001 or the memory 1002, and the processor 1001 performs an operation to control the communication of the communication device 1004 and the reading and/or writing of data from and/or to the memory 1002 and the storage 1003.

The processor 1001 operates, for example, an operating system to control the overall operation of the computer. The processor 1001 may be a central processing unit (CPU) including, for example, an interface with peripheral devices, a control device, an arithmetic device, and a register. For example, the waveform configuration setting unit 105 and the downlink control information generation unit 107 in the base station 10, the waveform configuration setting unit 205 and the waveform determination unit 207 in the user equipment 20, and so on may be implemented in the processor 1001.

The processor 1001 reads a program (program code), a software module, and/or data from the storage 1003 and/or the communication device 1004 to the memory 1002 and performs various types of processes according to the program, the software module, or the data. A program that causes a computer to perform at least some of the operations described in the embodiment may be used. For example, the waveform configuration setting unit 105 and the downlink control information generation unit 107 in the base station 10 and the waveform configuration setting unit 205 and the waveform determination unit 207 in the user equipment 20 may be implemented by a control program that is stored in the memory 1002 and is executed by the processor 1001. The other functional blocks may be similarly implemented. In the embodiment, the above-mentioned various processes are performed by one processor 1001. However, the processes may be simultaneously or sequentially performed by two or more processors 1001. The processor 1001 may be mounted on one or more chips. The program may be transmitted over the network through a telecommunication line.

The memory 1002 is a computer-readable recording medium and may include, for example, at least one of a read only memory (ROM), an erasable programmable ROM (EPROM), an electrically erasable programmable ROM (EEPROM), and a random access memory (RAM). The memory 1002 may be also referred to as, for example, a register, a cache, or a main memory (main storage device). The memory 1002 can store, for example, an executable program (program code) and a software module that can perform an uplink signal transmission method according to the embodiment of the invention.

The storage 1003 is a computer-readable recording medium and may include, for example, at least one of an optical disk such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be also referred to as an auxiliary storage device. The above-mentioned storage medium may be, for example, a database, a server, and other suitable media including the memory 1002 and/or the storage 1003.

The communication device 1004 is hardware (a transmission and reception device) for communicating with a computer through a wired and/or wireless network and is also referred to as, for example, a network device, a network controller, a network card, or a communication module. For example, the transmission unit 101, the reception unit 103, the reception unit 201, and the transmission unit 203, and the like may be implemented by the communication device 1004.

The input device 1005 is an input unit (for example, a keyboard, a mouse, a microphone, a switch, a button, or a sensor) that receives an input from the outside. The output device 1006 is an output unit (for example, a display, a speaker, or an LED lamp) that performs an output process to the outside. The input device 1005 and the output device 1006 may be integrated into a single device (for example, a touch panel).

Devices such as the processor 1001 and/or the memory 1002 are connected to each other via the bus 1007 for information communication. The bus 1007 may be a single bus or the devices may be connected to each other by different buses.

Each of the base station 10 and the user equipment 20 may include hardware such as a microprocessor, a digital signal processor (DSP), an application specific integrated circuit (ASIC), a programmable logic device (PLD), and a field programmable gate array (FPGA). Some or all of the functional blocks may be implemented by the hardware. For example, the processor 1001 may be implemented by at least one of these hardware components.

### Effects of Embodiment of Present Invention

According to the embodiment of the present invention, it is possible to implement transmission and reception of uplink signals between the base station eNB and the user equipment UE in the radio communication system to which the single carrier scheme and the multicarrier scheme are applicable in the uplink communication, by determining by the user equipment UE which of the schemes is used for the uplink communication based on information transmitted from the base station.

Since the waveform determination can be performed based on DCI transmitted from the base station eNB to the user equipment UE and the waveform determination criterion, it is not necessary to add new control information for transmission of the waveform. Furthermore, since it is also possible to set different waveforms for the PUCCH and the PUSCH, a flexible setting can be implemented, and high speed communication and large capacity can be implemented, for example, by always applying the multicarrier scheme to the data channel.

Further, when a waveform is dynamically determined, it is possible to make the best possible use of an advantage that high throughput is achieved by the multicarrier scheme and an advantage that a wide coverage is achieved by the single carrier scheme.

On the other hand, when a waveform is determined in the semi-static manner, it is possible to simplify the process of the user equipment UE related to the determination.

### Supplement

Each aspect/embodiment described in the specification may be applied to systems using Long Term Evolution (LTE), LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-WideBand (UWB), Bluetooth (registered trademark), and other suitable systems and/or next-generation systems that have functionality enhanced based on these systems.

The terms “system” and “network” used in the specification are interchangeably used.

In the specification, a specific operation performed by the base station may be performed by an upper node of the base station. In a network having one or a plurality of network nodes including the base station, it is clearly understood that various operations performed for communication with the user equipment can be performed by the base station and/or a network node (for example, including an MME or an S-GW without limitation) other than the base station. The number of network nodes other than the base station is not limited to one, and a plurality of other network nodes (for example, an MME and an S-GW) may be combined with each other.

Information or the like can be output from a higher layer (or a lower layer) to a lower layer (or a higher layer). Information or the like may be input or output via a plurality of network nodes.

The input or output information or the like may be stored in a specific location (for example, a memory) or may be managed in a management table. The input or output information or the like may be overwritten, updated, or edited. The output information or the like may be deleted. The input information or the like may be transmitted to another apparatus.

The transmission of information is not limited to the aspects/embodiments described in the specification and may be performed by other means. For example, the transmission of information may be performed by physical layer signaling (for example, downlink control information (DCI) or uplink control information (UCI)), higher layer signaling (for example, radio resource control (RRC) signaling, medium access control (MAC) signaling, or broadcast information (a master information block (MIB) and a system information block (SIB))), another signal, or a combination thereof. The RRC signaling may be also referred to as an RRC message and may be, for example, an RRC connection setup message or an RRC connection reconfiguration message.

Determination may be made based on a value (0 or 1) represented by 1 bit, may be made based on a true or false value (boolean: true or false), or may be made based on comparison with a numerical value (for example, comparison with a predetermined value).

Regardless of the fact that software is referred to as software, firmware, middleware, a microcode, a hardware description language, or another name, the software is broadly interpreted to include an instruction, an instruction set, a code, a code segment, a program code, a program, a sub-program, a software module, an application, a software application, a software package, a routine, a subroutine, an object, an executable file, an execution thread, a procedure, a function, or the like.

Software, an instruction, or the like may be transmitted or received via a transmission medium. For example, when software is transmitted from a website, a server, or another remote source using a wired technology such as a coaxial cable, an optical cable, a twisted pair, and a digital subscriber line (DSL) and/or a wireless technology such as an infrared ray, radio, and microwaves, the wired technology and/or the wireless technology is included in the definition of a transmission medium.

The information, the signal, and the like described in the specification may be represented using any of various technologies. For example, the data, the instruction, the command, the information, the signal, the bit, the symbol, the chip, and the like mentioned throughout the description may be represented by a voltage, a current, an electromagnetic wave, a magnetic field, or a magnetic particle, an optical field or a photon, or any combination thereof.

The terms described in the specification and/or terms necessary to understand the specification may be replaced with terms that have same or similar meanings. For example, a channel and/or a symbol may be a signal. A signal may be a message. A component carrier (CC) may be referred to as a carrier frequency, a cell, or the like.

The information, the parameter, or the like described in the specification may be represented by an absolute value, may be represented by a relative value from a predetermined value, or may be represented by another piece of corresponding information. For example, a radio resource may be indicated using an index.

The names used for the above-described parameters are not limited in any respect. Further, a numerical expression or the like in which the parameters are used can be different from the numerical expression disclosed explicitly in the specification. Since various channels (for example, a PUCCH and a PDCCH) and information elements (for example, TPC) can be identified with any suitable names, various names allocated to the various channels and the information elements are not limited in any respect.

The terms “determining” and “deciding” used in the specification include various operations. The terms “determining” and “deciding” can include, for example, “determination” and “decision” for calculating, computing, processing, deriving, investigating, looking-up (for example, looking-up in a table, a database, or another data structure), and ascertaining operations. In addition, the terms “determining” and “deciding” can include “determination” and “decision” for receiving (for example, information reception), transmitting (for example, information transmission), input, output, and accessing (for example, accessing data in a memory) operations. The terms “determining” and “deciding” can include “determination” and “decision” for resolving, selecting, choosing, establishing, and comparing operations. That is, the terms “determining” and “deciding” can include “determination” and “decision” for any operation.

The term “based on” used in the specification does not mean “only based on” unless otherwise stated. In other words, the term “based on” means both “only based on” and “at least based on”.

When reference is made to elements in which terms “first,” “second,” and the like are used in the specification, the number or the order of the elements is not generally limited. These terms can be used in the specification as a method to conveniently distinguish two or more elements from each other. Accordingly, reference to first and second elements does not imply that only two elements are employed or the first element is prior to the second element in some ways.

The terms “include” and “including” and the modifications thereof are intended to be inclusive, similarly to the term “comprising”, as long as they are used in the specification or the claims. In addition, the term “or” used in the specification or the claims does not mean exclusive OR.

In each aspect/embodiment described in the specification, for example, the order of the processes in the procedure, the sequence, and the flowchart may be changed unless a contradiction arises. For example, for the method described in the specification, elements of various steps are presented in the exemplified order. However, the invention is not limited to the presented specific order.

The aspects/embodiments described in the specification may be individually used, may be combined, or may be switched during execution. In addition, transmission of predetermined information (for example, transmission of “being X”) is not limited to being performed explicitly, but may be performed implicitly (for example, the transmission of the predetermined information is not performed).

The invention has been described in detail above. It will be apparent to those skilled in the art that the invention is not limited to the embodiments described in the specification. Various modifications and changes can be made, without departing from the scope and spirit of the invention described in the claims. Therefore, the embodiments described in the specification are illustrative and do not limit the invention.

The present international application is based on and claims the benefit of priority of Japanese Patent Application No. 2016-215706 filed on Nov. 2, 2016, the entire contents of which are hereby incorporated by reference.

### DESCRIPTION OF NOTATIONS

10 base station

101 transmission unit

103 reception unit

105 waveform configuration setting unit

107 downlink control information generation unit

20 user equipment

201 reception unit

203 transmission unit

205 waveform configuration setting unit

207 waveform determination unit

1001 processor

1002 memory

1003 storage

1004 communication device

1005 input device

1006 output device

1. A user equipment that transmits an uplink signal to a base station using one of a multicarrier scheme and a single carrier scheme, comprising:
a reception unit that receives downlink control information from the base station through a downlink control channel;
a determination unit that determines whether the multicarrier scheme is used or the single carrier scheme is used based on the received downlink control information; and a transmission unit that transmits the uplink signal using the determined scheme.

2. The user equipment according to claim 1,
wherein the reception unit receives a determination criterion of whether the multicarrier scheme is used or the single carrier scheme is used from the base station, and
the determination unit determines whether the multicarrier scheme is used or the single carrier scheme is used based on information obtained by decoding the received downlink control information and the determination criterion.

3. The user equipment according to claim 1,
wherein the determination unit determines whether the multicarrier scheme is used or the single carrier scheme is used based on downlink control information received after a predetermined time has elapsed since the user equipment transmitted control information to the base station or downlink control information received after a fixed time has elapsed.

4. An uplink signal transmission method in a user equipment that transmits an uplink signal to a base station using one of a multicarrier scheme and a single carrier scheme, comprising the steps of:
receiving downlink control information from the base station through a downlink control channel;
determining whether the multicarrier scheme is used or the single carrier scheme is used based on the received downlink control information; and
transmitting an uplink signal using the determined scheme.

5. The user equipment according to claim 2,
wherein the determination unit determines whether the multicarrier scheme is used or the single carrier scheme is used based on downlink control information received after a predetermined time has elapsed since the user equipment transmitted control information to the base station or downlink control information received after a fixed time has elapsed.
